(19) United States
(12) Patent Application Publication
(10) Pub. No.: US 2012/0043249 A1
(43) Pub. Date: Feb. 23, 2012

(54) BUFFER MATERIAL AND PACKING DEVICE

(76) Inventor: Katsumi Tsukii, Tokyo (JP)

(21) Appl. No.: 13/258,920

(22) PCT Filed: Apr. 14, 2010
(86) PCT No.: PCT/JP2010/056959

§ 371 Date: Sep. 22, 2011

(30) Foreign Application Priority Data
Apr. 15, 2009 (JP) 2009-098890

(51) Int. Cl. B65D 81/02; B32B 3/02; B32B 3/28; B32B 3/10

(52) U.S. Cl. 206/521; 428/192; 428/182

(57) ABSTRACT

The present invention provides a buffer material and packing device having sufficient buffering performance and not requiring complex buffering designs. A buffer material includes: a work-holding surface section which is substantially a quadrilateral in shape and holds a work; a work-movement-regulating section which is formed at least one side of a predetermined pair of facing sides of the work-holding surface section, and, by its one predetermined surface's being in contact with the work, regulates the movement of the work in the direction of the contact; a cut-out portion which is formed at a predetermined position in the work-movement-regulating section so that a projection section formed on the work is inserted in it. The cut-out portion is cut out in such a manner that the distance between an inner wall surface formed by the cut-out portion in the work-movement-regulating section and a facing surface of the projection section that faces to the inner wall surface increases with increasing distance in the opposite direction from the surface in contact with the work, of the work-movement-regulating section.

### TECHNICAL FIELD

The present invention relates to a buffer material and a packing device which protect a packing object from shocks.

### BACKGROUND ART

When a packing object such as a personal computer, display and printer is packed, a buffer material is widely employed so as to interpose between a packing case and the packing object and thereby protect the packing object from the shocks caused by a falling or collision with other objects, of the packing case.

For example, as shown in FIG. 11, patent document 1 filed by the inventor of the present invention discloses a buffer material 1 for protecting a work W in a packing case 9 from shocks. This buffer material 1 includes a work-holding surface section 2 to hold the work W, supporting sections 3a and 3b formed, for example, on each of a pair of sides facing each other in the shorter direction of the work-holding surface section 2, and work-movement-regulating sections 4a and 4b formed, for example, at each of a pair of sides facing each other in the longer direction of the work-holding surface section 2. Here, at respective predetermined positions of the work-movement-regulating sections 4a and 4b, cut-out portions 6a and 6b are formed so that projection sections 5a and 5b formed in the work W are inserted in them. By inserting the projection sections 5a and 5b into the respective cut-out portions 6a and 6b, movement of the work W in the shorter direction is regulated.

### PRIOR ART DOCUMENT

### Patent Document

[Patent Document 1] Japanese Patent Application Laid-Open No. 2008-308178

### DISCLOSURE OF THE INVENTION

### Problems to be solved by the invention

By the way, the projection sections 5a and 5b are formed, for example, out of a sheet metal member. As generalization, when the projection sections 5a and 5b are made out of a thin sheet metal member (that is, when the sheet thickness of the sheet metal member is not sufficiently large compared to the length), the projection sections 5a and 5b may not secure sufficient strength. In particular, when their top portions are subjected to strong force, there is increased possibility of damage to the projection sections 5a and 5b (for example, their bending over from the base portion or overall curving).

FIG. 12 shows an enlarged plan view around the cut-out portion 6a formed in the work-movement-regulating section 4a. In the patent document 1, the cut-out portion 6a is formed into the shape fitting that of the projection section 5a. Here, for example, when the work W in a packed state is dropped in the direction indicated by the arrow in FIG. 12 (that is, when the packing case 9 in the state illustrated in FIG. 11 is turned over toward this side and dropped), a buffer area A of the buffer material 1 crushes due to the shock-load of the dropping, and the shock is relieved through the crushing, and thereby the work W is protected. When the buffer area A crushes, the projection section 5a is subjected to a certain magnitude of force from the buffer area A in the direction opposite to that indicated by the arrow in FIG. 12.

Here, there is a restriction that the sheet thickness of the projection sections 5a and 5b is not allowed to be sufficiently large, because of recent strong demands for the weight saving of the work W including the projection sections 5a and 5b. In some cases there is no choice but to use the projection sections 5a and 5b not having sufficient strength. Accordingly, in packing processes, it is necessary to protect also these projection sections 5a and 5b from shocks, as well as the work W.

However, because the cut-out portion 6a is formed in the shape fitting that of the projection section 5a as described above, a top portion 8 of the projection section 5a is subjected to the force substantially equivalent to that a base portion 7 is subjected to. That is, because the top portion 8 is subjected to a strong force, the risk of damage of the projection section 5a increases when the projection sections 5a and 5b do not have sufficient strength (that is, when the sheet thickness is small compared to the length) as described above. On the other hand; if the buffer area A is made easier to crush, it may be possible to relieve the force the top portion 8 is subjected to, and consequently to avoid the damage of projection section 5a. However, if the buffer area A is made too easy to crush, the possibility that the work W itself cannot be protected from shocks increases, in turn.

That is, when the shape of the cut-out portion 6a was made to fit that of the projection section 5a and the projection sections 5a and 5b do not have sufficient strength, as presented in the patent document 1, packing designers need to make complex buffer designs specifically for each product so as to achieve both the protection of the work W and the prevention of damage of the projection section 5a.

The present invention is made in order to solve the above-described problem, and its object is to provide a buffer material and packing device having sufficient buffering performance but not requiring complex buffer designs.

### Means for solving the Problem

In order to solve the above-described problem, a buffer material of the present invention includes: a work-holding surface section which is substantially quadrilateral in shape and holds a work; a work-movement-regulating section which is formed at least one side of a predetermined pair of facing sides of the work-holding surface section, and, by its one predetermined surface's being in contact with the work, regulates the movement of the work in the direction of the contact; a cut-out portion which is formed at a predetermined position in the work-movement-regulating section so that a projection section formed on the work is inserted in it:

wherein the cut-out portion is cut out in such a manner that the distance between an inner wall surface formed by the cut-out portion in the work-movement-regulating section and the facing surface of the projection section which is opposite to the inner wall surface increases with increasing distance in the opposite direction from the surface in contact with the work, of the work-movement-regulating section.

Further, a packing device of the present invention includes a packing case and buffer material for protecting a work in the packing case from shocks, wherein the buffer material includes: a work-holding surface section which is substantially square in shape and holds a work; a work-movement-regulating section which is formed at least one side of a predetermined pair of facing sides of the work-holding surface section, and, by its one predetermined surface's being in contact with the work, regulates the movement of the work in the direction of the contact; a cut-out portion which is formed at a predetermined position in the

work-movement-regulating section so that a projection section formed on the work is inserted in it: and further in the buffer material, the cut-out portion is cut out in such a manner that the distance between an inner wall surface formed by the cut-out portion in the work-movement-regulating section and the facing surface of the projection section which is opposite to the inner wall surface increases with increasing distance in the opposite direction from the surface in contact with the work, of the work-movement-regulating section.

### Advantageous Effects of Invention

According to the present invention, there is provided a buffer material and packing device having sufficient buffering performance but not requiring complex buffer designs.

### BRIEF DESCRIPTION OF THE DRAWINGS

FIG. 1 is a perspective view for describing an exemplary configuration of a packing device according to the first exemplary embodiment of the present invention.

FIG. 2 is an enlarged plan view around a cut-out portion shown in FIG. 1.

FIG. 3 is diagrams showing a transition of the buffer area crushing when the packing case containing a work is dropped in the direction indicated by the arrow, where (a) shows a state diagram for an initial stage of the crush, and (b) shows a state diagram for a final stage of the crush.

FIG. 4 is an enlarged plan view around the cut-out portion showing the first example of a shape of the cut-out portion in the first exemplary embodiment.

FIG. 5 is an enlarged plan view around the cut-out portion showing the second example of a shape of the cut-out portion in the first exemplary embodiment.

FIG. 6 is an enlarged plan view around the cut-out portion showing the third example of a shape of the cut-out portion in the first exemplary embodiment.

FIG. 7 is an enlarged plan view around the cut-out portion showing the fourth example of a shape of the cut-out portion in the first exemplary embodiment.

FIG. 8 is a partial perspective view of a first buffer material for describing an exemplary configuration of the first buffer material according to the second exemplary embodiment of the present invention.

FIG. 9 is a diagram for describing the way a shock-load due to the dropping of the packing case is dispersed by a triangular hole portion, when the packing case containing a work is dropped in the direction indicated by a thin arrow in the diagram, and is a plan view of the work-contacting surface of the first buffer material shown in FIG. 8.

FIG. 10 is a fragmentary perspective view for describing another exemplary configuration of the first buffer material of the second exemplary embodiment shown in FIG. 8.

FIG. 11 is a perspective view for describing a structure of buffer material as a related art.

FIG. 12 is an enlarged plan view around a cut-out portion formed in the work-movement-regulating sections shown in FIG. 11.

### MODE FOR CARRYING OUT THE INVENTION

### First Exemplary Embodiment

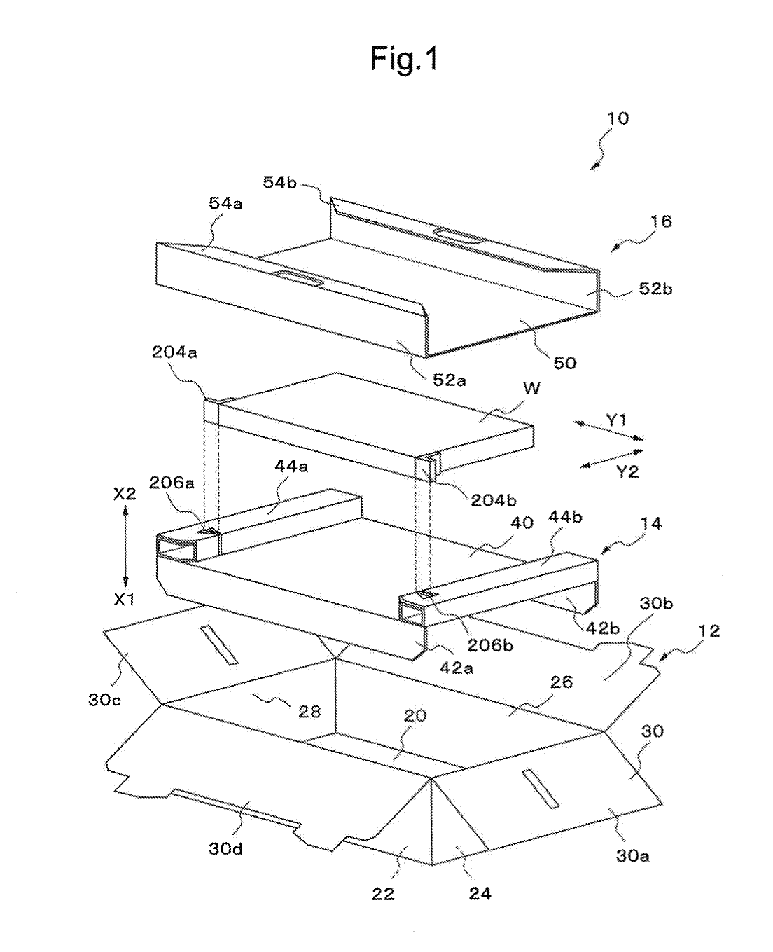

FIG. 1 is a perspective view for describing an exemplary configuration of a packing device 10 according to the first exemplary embodiment of the present invention. This packing device 10 includes a packing case 12, first buffer material 14 and second buffer material 16. The packing case 12, the first buffer material 14 and the second buffer material 16 are formed out of the same or the same kind of elastic sheet-shaped members, for example, corrugated cardboard. In the description given below, this sheet-shaped member is assumed to be corrugated cardboard.

The packing case 12 includes a bottom surface section 20, side surface sections 22, 24, 26 and 28 and a ceiling surface section 30. The ceiling surface section 30 includes ceiling flaps 30a-30d which can be opened and closed. As recognized from FIG. 1, inside the packing case 12, the first buffer material 14, work W and the second buffer material 16 are arranged in order from the bottom.

The first buffer material 14 includes a work-holding surface section 40, supporting sections 42a and 42b, and work-movement-regulating sections 44a and 44b.

The work-holding surface section 40 is substantially quadrilateral in shape and holds the work W. The supporting sections 42a and 42b are formed, for example, on each side of a pair of facing sides, on the work-holding surface section 40, facing each other in the shorter direction (the direction indicated by arrow Y2 in FIG. 1), and extends in the first direction (the direction indicated by arrow X1 in FIG. 1) which intersects with the work-holding surface section 40 at substantially right angles. The supporting sections 42a and 42b support the first buffer material 14, by having their top portions in contact with the bottom surface section 20 of the packing case 12.

Work-movement-regulating sections 44a and 44b are formed, for example, at each side of a pair of facing sides, on the work-holding surface section 40, facing each other in the longer direction (the direction indicated by arrow Y1 in FIG. 1). The work-movement-regulating sections 44a and 44b are formed in the shape of, for example, a hollow rectangular parallelepiped. By the contact of predetermined surfaces of the rectangular parallelepiped with the work W, the movement of the work W in the longer direction is regulated.

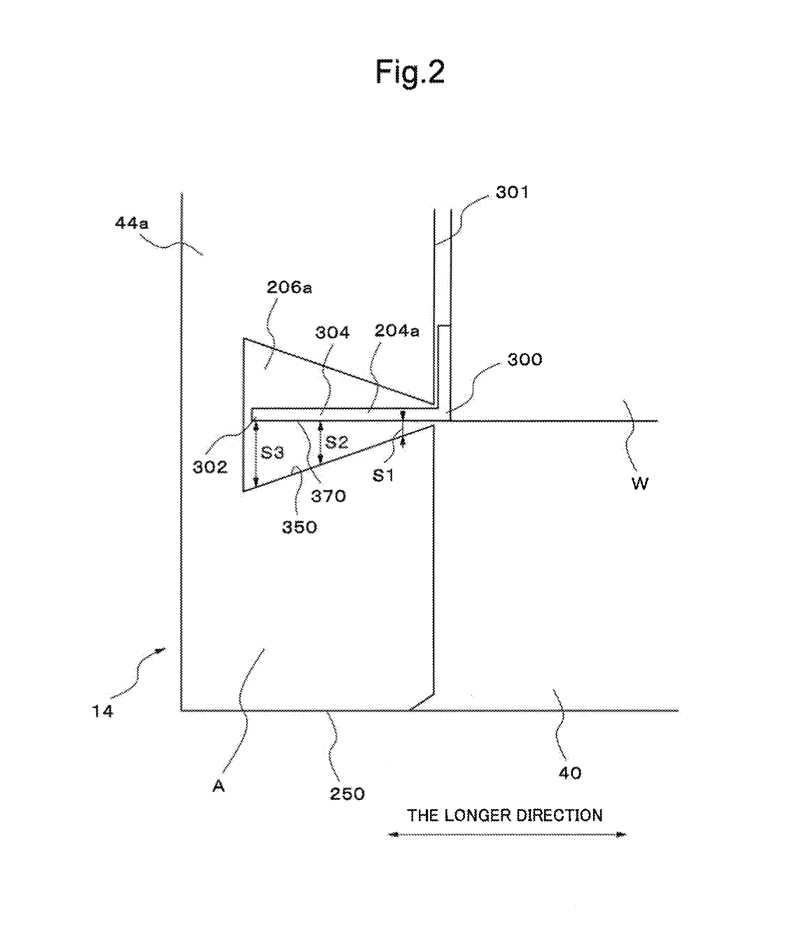

At respective predetermined positions in the work-movement-regulating sections 44a and 44b, cut-out portions 206a and 206b are formed so as to have projection sections 204a and 204b, formed on the work W, inserted in them. FIG. 2 shows an enlarged plan view around the cut-out portion 206a. Here, the cut-out portion 206b may be different from in the position, direction or size of its formation. However, its shape is identical with the cut-out portion 206a, and therefore the description of the cut-out portion 206b will be omitted.

As recognized from FIG. 2, the cut-out portion 206a is cut out in such a manner that the distance between an inner wall surface 350 formed by the cut-out portion 206a in the work-movement-regulating section 44a and the facing surface 370 of the projection section 204a which is opposite to the inner wall surface 350 gradually increases with increasing distance in the opposite direction (that is, toward the left side edge portion in the longer direction) from the surface 301, in contact with the work, of the work-movement-regulating section 44a. That is, when the distance between the facing surface 370 and the inner wall surface 350 at the base portion 300 of the projection section 204a is expressed by S1, the distance between the facing surface 370 and the inner wall surface 350 at the middle portion 304 of the projection section 204a by S2, and the distance between the facing surface 370 and the inner wall surface 350 at the top portion 302 of the projection section 204a by S3, the relation between the distances S1-S3 is expressed as distance S3>distance S2>distance S1. The area between the near side edge portion 250 of the work-movement-regulating section 44a and the inner wall surface 350 of the cut-out portion 206a is a buffer area A which crushes to protect the work W when being subjected to a shock-load.

The following description will be made referring to FIG. 1 again. The second buffer material 16 includes a work-holding surface section 50 and supporting sections 52a and 52b. The work-holding surface section 50 is a space for holding the work W from the direction opposite to that of the work-holding surface section 40 of the first buffer material 14 (that is, from the ceiling side). The work-holding surface section 50 is formed in a shape of substantially quadrilateral. The supporting sections 52a and 52b are formed, for example, on each side of a pair of facing sides, on the work-holding surface section 50, facing each other in the shorter direction (the direction indicated by arrow Y2 in FIG. 1), and extends in the first direction (the direction indicated by arrow X2 in FIG. 1) which intersects with the work-holding surface section 50 at substantially right angles. The top portions of the supporting sections 52a and 52b are bent inside to form contact sections 54a and 54b. The contact sections 54a and 54b are in contact with the ceiling surface section 30 of the packing case 12. That is, when the work W is packed, the second buffer material 16 is arranged at the ceiling area of the packing case 12. The work-holding surface section 50 holds the work W from the ceiling side by a pressing force toward the bottom direction which the contact sections 54a and 54b are subjected to.

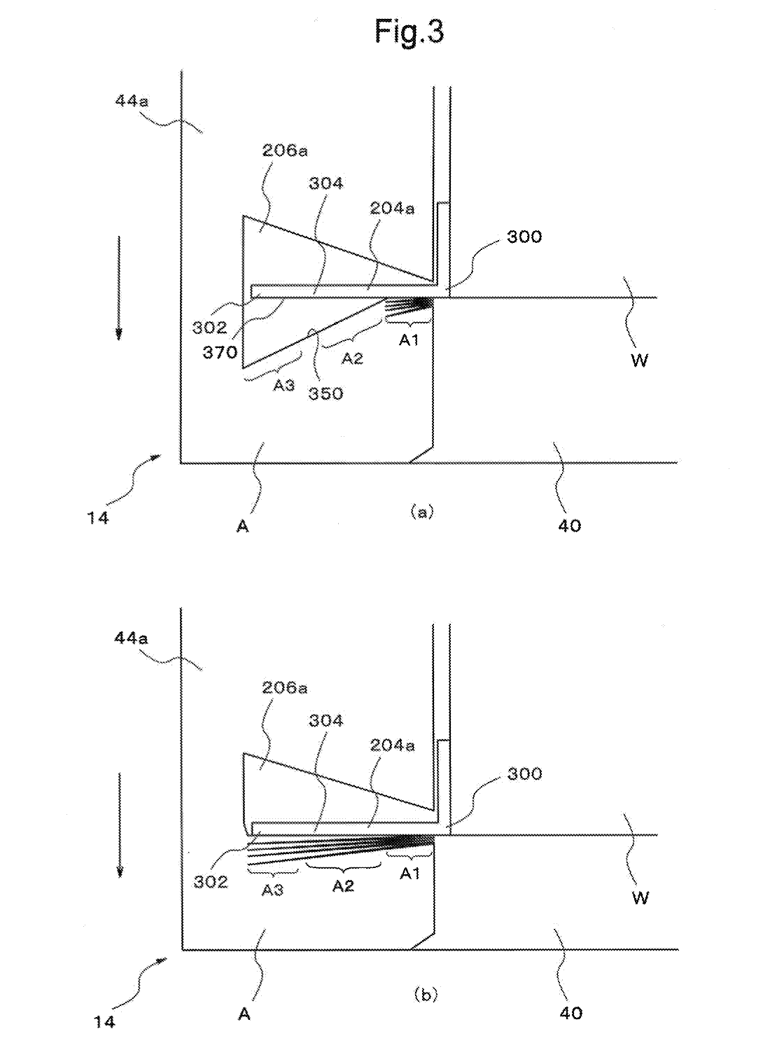

FIG. 3 shows a transition of a crushing of the buffer area A when the packing case 12 containing the work W is dropped in the direction indicated by the arrow in the figure (that is, when the packing case 12 in the state illustrated in FIG. 1 is turned over toward this side and dropped). To be more specific, FIG. 3(a) shows a state diagram for an initial stage of the crushing, and FIG. 3(b) shows a state diagram for a final stage of the crushing. When subjected to a shock-load due to the dropping, first, at the base portion 300 of the projection section 204a, the facing surface 370 and the inner wall surface 350 become in contact with each other, and consequently a base-side region A-1 of the buffer area A crushes (FIG. 3 (a) is referred to). In this stage, at the top portion 302 of the projection section 204a, the facing surface 370 and the inner wall surface 350 have not become in contact with each other yet. After that, at the middle portion 304 of the projection section 204a, the facing surface 370 and the inner wall surface 350 gradually become in contact with each other, and consequently the middle region A-2 of the buffer area A crushes. In the final stage, the facing surface 370 and the inner wall surface 350 become in contact with each other at the top portion 302 of the projection section 204a, and consequently the top-portion-side region A-3 of the buffer area A crushes (FIG. 3 (b) is referred to). In this situation, the shock which the projection section 204 is subjected to is largest at the base portion 300, is relieved gradually as it propagates to the middle portion 304, and is fairly weakened or completely vanished when reaching the top portion 302. There may be a case where the shock-load due to the dropping is relatively weak, and therefore the buffering motion ends at the middle portion 304 before the shock-load reaches the top portion 302.

As has been described above, the top portion 302 of the projection section 204a inserted in the cut-out portion 206a having the shape such as of this exemplary embodiment is never subjected to so strong shock as that the base portion is subjected to. Accordingly, damage (bending over from the base portion or overall curving) of the projection section 204a is avoided.

Moreover, by making the cut-out portion 206a into the shape described above, it becomes unnecessary to be concerned about at least the damage of the projection section 204a. Packing designers are relieved from complex buffer designs. That is, it becomes possible to achieve both the protection of work W and the prevention of damage of the projection section 204a without requiring a lot of effort.

Further, in the normal state, because the base portion 300 of the projection section 204a is supported by the entrance portion of the cut-out portion 206a (that is, the portion where the distance between the facing surface 370 of the projection section 204a and the inner wall surface 350 is smallest), the movement of work W in the shorter direction (the direction indicated by arrow Y2 in FIG. 1) is regulated as in the case the cut-out portion is formed into the shape fitting the projection section 204a.

Here, the shape and size of cut-out portion 206a may be determined appropriately according to the characteristics of work W (the weight of work W itself and the strength of projection section 204a). It is not necessary to form a cut-out portion in both of the work-movement-regulating sections 44a and 44b. The number of cut-out portions is not necessary to be one, and, for example, a plurality of cut-out portions may be formed according to the work W.

The shape of the cut-out portion 206a can be those described below, for example.

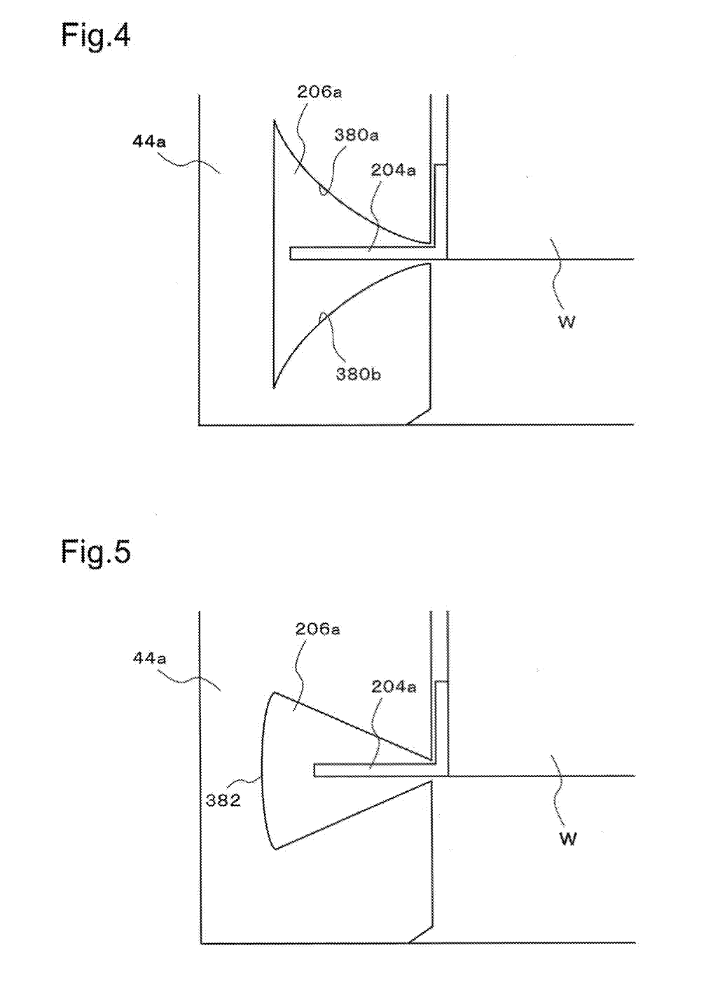

FIG. 4 is an enlarged plan view around the cut-out portion showing the first example of a shape of the cut-out portion 206a in the first exemplary embodiment. In the case of the cut-out portion 206a shown in FIG. 4, two sides 380a and 380b both facing to the projection section 204a may be cut out into a curved line shape (in a curved surface shape, when described in three dimensions).

FIG. 5 is an enlarged plan view around the cut-out portion showing the second example of a shape of the cut-out portion 206a in the first exemplary embodiment. In the case of the cut-out portion 206a shown in FIG. 5, a side 382 located on the apex-portion side of the projection section 204a does not need to be a straight line but may be a curved line. In FIG. 5, the case with a side 382 curving outward is illustrated as an example, but the side 382 may be curved inward.

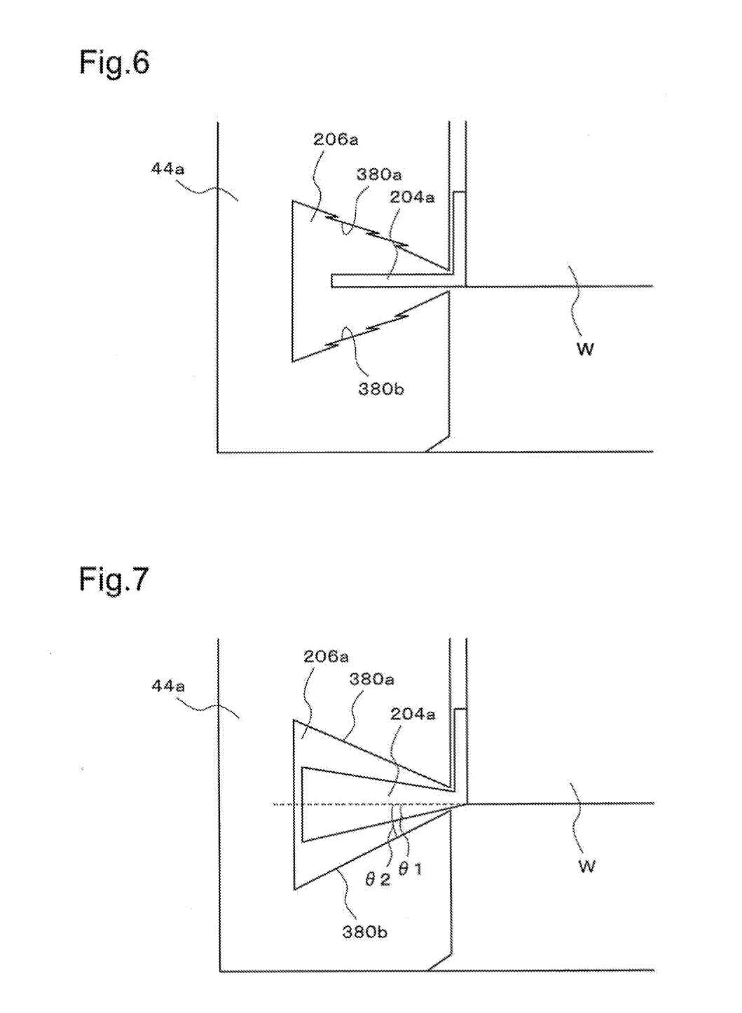

FIG. 6 is an enlarged plan view around the cut-out portion showing the third example of a shape of the cut-out portion 206a in the first exemplary embodiment. In the case of the cut-out portion 206a shown in a FIG. 6, two sides 380a and 380b both facing to the projection section 204a may be cut out into a saw-tooth-like shape (in a step-like shape, when described in three dimensions).

FIG. 7 is an enlarged plan view around the cut-out portion showing the fourth example of a shape of the cut-out portion 206a in the first exemplary embodiment. Here, the sheet thickness of the projection section 204 gradually increases making a first angle θ1, as it approaches the top portion. In this case, the two sides 380a and 380b of the cut-out portion 206a are cut out such that they gradually expand making a first angle θ2 which is larger than the first angle θ1.

That is, what is necessary is that the cut-out portion 204a is cut out in such a shape that the distance between the inner wall surface 350 formed by the cut-out portion 206a in the work-movement-regulating section 44a and the facing surface 370, of the projection section 204a, opposite to the inner wall surface 350 gradually increases with increasing distance in the opposite direction, and therefore the shape of the cut-out portion 204a is not limited to those shown in FIGS. 2 and 4-7 described above.

### Second Exemplary Embodiment

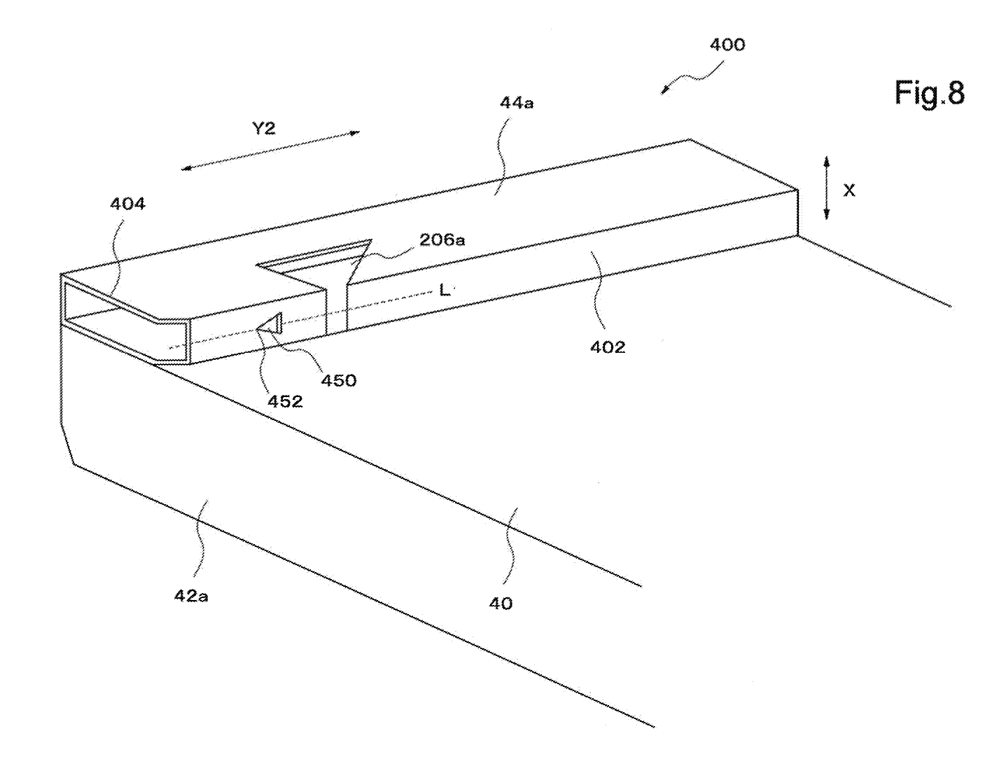

FIG. 8 is a fragmentary perspective view of a first buffer material 400 for describing an exemplary configuration of the first buffer material 400 according to the second exemplary embodiment of the present invention. Here, in the first buffer material 400 of the second exemplary embodiment, reference signs identical with that in the first buffer material 14 of the first exemplary embodiment are assigned to the components identical with that in the first buffer material 14, and their descriptions are omitted. Additionally, although they are not shown in FIG. 8, the components other than the first buffer material 400 of the packing device 10, that is, the packing case and the second buffer material are identical with the packing case 12 and the second buffer material 16, respectively, of the first exemplary embodiment.

The first buffer material 400 is different from the first buffer material 14 in that it further has a triangular hole portion 450 formed at a predetermined position in a surface 402, in contact with the work W, of the work-movement-regulating section 44a. More specifically, the triangular hole portion 450 is formed between the cut-out portion 206a and the edge portion on the side near the cut-out portion 206a (an edge portion 404 in the case of FIG. 8) in the direction the work-movement-regulating section 44a extends (the direction indicated by arrow Y2 in FIG. 8), with its apex portion 452 directed toward the edge portion 404. Here, the triangular hole portion 450 is substantially a equilateral triangle in shape, and symmetrically arranged with respect to the center line L about the width direction (the direction indicated by arrow X in FIG. 8) of the surface 402 in contact with the work.

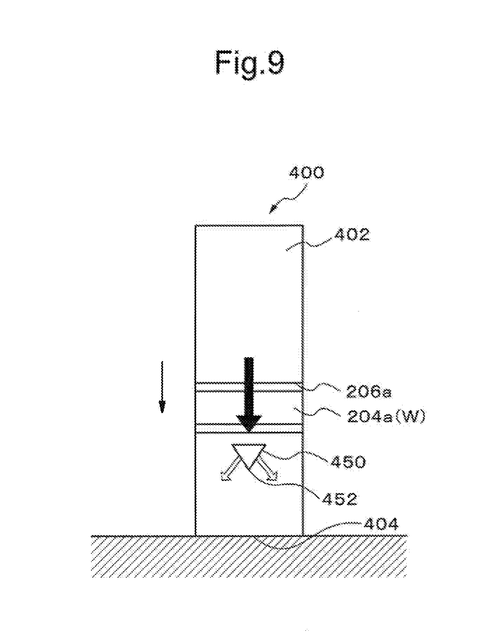

FIG. 9 is a diagram for describing the way a shock-load due to the dropping of the packing case 12 is dispersed by a triangular hole portion 450, when the packing case 12 containing the work W is dropped in the direction indicated by a thin arrow in the diagram, wherein the diagram being a plan view of the surface 402, in contact with the work, of the first buffer material 400 shown in FIG. 8.

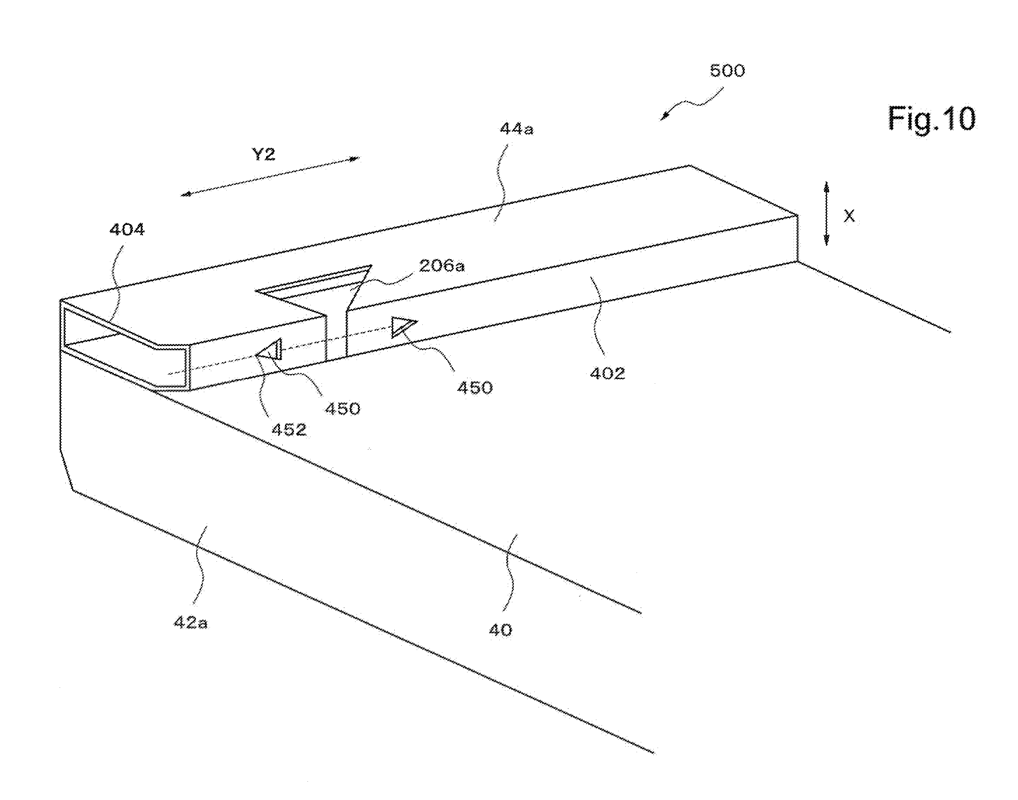

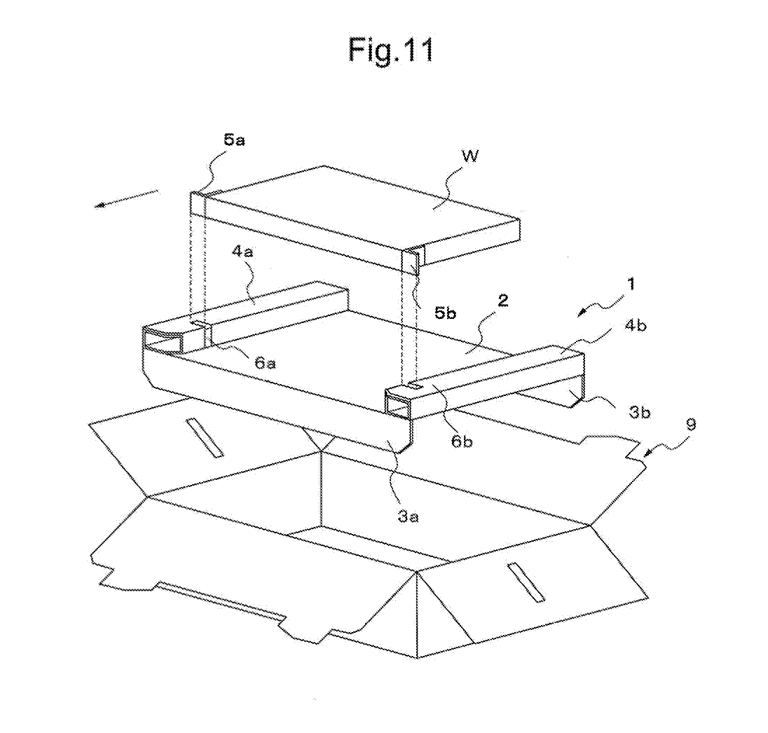

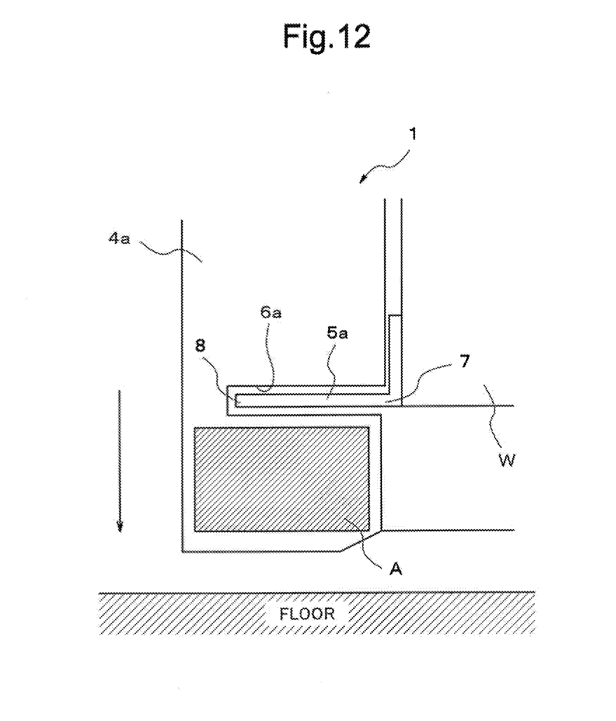

When the packing case 12 collides with a floor, the triangular hole portion 450 is subjected to a shock-load from the direction indicated by a thick arrow in FIG. 9. Through the crushing of the two sides adjacent to each other containing the apex portion 452 of the triangular hole portion 450, in the two respective directions indicated by the arrow outlines with blank inside in FIG. 10, the shock-load is dispersed in these two respective directions. Here, as described above, the triangular hole portion 450 is a equilateral triangle in shape, and symmetrically arranged with respect to the center line L about the width direction of the surface 402 in contact with the work. Therefore, in this case, the magnitudes of the dispersed shock-loads in the two respective directions become the same.

As has been described above, by providing a triangular hole portion 450 such as that in the present exemplary embodiment, it becomes possible to disperse the shock-load in any direction desirable for the dispersion in accordance with the work W. With this configuration, the direction of the shock-load can be controlled certainly and easily. Accordingly, there may not be a case where the direction of the shock-load is uncertain and consequently, for example, concentrated at one unexpected point (a region of particularly low strength, for example, a region extremely easy to crush). Therefore, damage of the work W is avoided certainly.

In addition, because the direction of dispersing the shock-load can be controlled, the buffering range can be designed to be that of minimum necessary. Accordingly, the first buffer material, thus the packing device, can be smaller in size.

In the above description, the triangular hole portion 450 was described to be substantially an equilateral triangle in shape and the position for arranging the triangular hole portion 450 was to be the center with respect to the width direction of the surface 402 in contact with the work. However, the shape and arranging position of the triangular hole portion 450 are not limited to those described above. The shape and arranging position of the triangular hole portion 450, and additionally the size and number of it, can be changed appropriately according to, for example, the characteristics of the work W (the weight and shape of the work W).

Here, FIG. 10 is a fragmentary perspective view of the first buffer material 500 for describing another exemplary configuration of the first buffer material 500 of the second exemplary embodiment shown in FIG. 8. In the first buffer material 500, the above-mentioned triangular hole portions 450 are formed at predetermined positions near the each end of the cut-out portion 206a, respectively. By doing this, the work W held by the cut-out portion 206a can be protected from the shock-loads applied from the both ends in the shorter direction (the direction indicated by arrow Y2 in FIG. 10).

### Modified Embodiment

In the first and second exemplary embodiments described above, the work-movement-regulating sections of the first buffer material do not need to be formed at each of a pair of facing sides, facing each other, of the work-holding surface section, but it may be possible that only one of them is formed at one of the sides. Further, the work-movement-regulating sections do not need to be formed over the entire region of each side, but may be formed at only a part of the sides. Further, the work-movement-regulating sections can be formed at each of a pair of facing sides facing each other in the shorter direction (the Y2 direction in FIG. 1, for example).

In the first and second exemplary embodiments described above, the shape of respective work-holding surface sections of the first and second buffer materials docs not need to be rectangular but may be square.

Further, in the first and second exemplary embodiments described above, there are no restrictions on the production means of the work-movement-regulating section of the first buffer material. For example, the work-movement-regulating section can be produced by folding a plurality of times a flap portion provided connectively to the work-holding surface section of the first buffer material, or by producing the work-movement-regulating section as a member independent of the work-holding surface section and fixing it at a predetermined position on the work-holding surface section by means of gluing, for example.

As above, the present invention has been described with reference to the exemplary embodiments, but the present invention is not limited to the above-described exemplary embodiments. Various changes which are easily understood by those skilled in the art within the scope of the present invention may be made with respect to the configurations and details of the present invention.

This application claims priority based on Japanese Patent Application No. 2009-098890, filed on Apr. 15, 2009, the disclosure of which is incorporated herein in its entirety.

### DESCRIPTION OF SYMBOLS

10 packing device
12 packing case
14, 400, 500 first buffer material
40 work-holding surface section
42a, 42b supporting section
44a, 44b work-movement-regulating section
204a, 204b projection section
206a, 206b cut-out portion
300 base portion
302 top portion
304 middle portion
350 inner wall surface
370 facing surface
402 surface in contact with a work
404 edge portion
450 triangular hole portion
452 apex portion A buffer area
A-1 base side region
A-2 middle region
A-3 top-portion side region
W work

1-14. (canceled)

15. A buffer material including:
a work-holding surface section which is substantially a quadrilateral in shape and holds a work;
a work-movement-regulating section which is formed at least to one side of a predetermined pair of facing sides of said work-holding surface section, and, by its one predetermined surface's being in contact with said work, regulates the movement of said work in the direction of said contact; and
a cut-out portion which is formed at a predetermined position in said work-movement-regulating section so that a projection section formed on said work is inserted in it,
wherein said cut-out portion is cut out in such a manner that the distance between an inner wall surface formed by said cut-out portion in said work-movement-regulating section and a facing surface of said projection section that faces to said inner wall surface increases with increasing distance in the opposite direction from the surface, in contact with said work, of said work-movement-regulating section.

16. The buffer material according to claim 15, wherein said cut-out portion is cut out in such a manner that the distance between an inner wall surface formed by said cut-out portion in said work-movement-regulating section and a facing surface of said projection section that faces to said inner wall surface gradually increases with increasing distance in the opposite direction from the surface, in contact with said work, of said work-movement-regulating section.

17. The buffer material according to claim 15, wherein the shape and size of said cut-out portion is determined on the basis of at least one of the weight of said work and the strength of said projection section.

18. The buffer material according to claim 15, wherein, in a surface in contact with said work, of said work-movement-regulating section, between one of the edges of said work-movement-regulating section and said cut-out portion, a triangular hole portion is formed, with its apex portion directed toward said edge side.

19. The buffer material according to claim 18, wherein said triangular hole portion is arranged substantially symmetrically with respect to a center line about the width direction of said work, in said surface in contact with said work.

20. The buffer material according to claim 18, wherein the shape, size and arranging position of said triangular hole portion is determined on the basis of at least one of the weight and shape of said work.

21. The buffer material according to claim 15, wherein said work-holding surface section and said work-movement-regulating section are formed out of corrugated cardboard.

22. A packing device including a packing case and a buffer material for protecting a work in said packing case from shocks, wherein said buffer material includes:
a work-holding surface section which is substantially a quadrilateral in shape and holds a work;
a work-movement-regulating section which is formed at least one side of a predetermined pair of facing sides of said work-holding surface section, and, by its one predetermined surface's being in contact with said work, regulates the movement of said work in the direction of said contact; and
a cut-out portion which is formed at a predetermined position in said work-movement-regulating section so that a projection section formed on said work is inserted in it,
and wherein said cut-out portion is cut out in such a manner that the distance between an inner wall surface formed by said cut-out portion in said work-movement-regulating section and a facing surface of said projection section that faces to said inner wall surface increases with increasing distance in the opposite direction from the surface, in contact with said work, of said work-movement-regulating section.

23. The packing device according to claim 22, wherein said cut-out portion is cut out in such a manner that the distance between an inner wall surface formed by said cut-out portion in said work-movement-regulating section and a facing surface of said projection section that faces to said inner wall surface gradually increases with increasing distance in the opposite direction from the surface, in contact with said work, of said work-movement-regulating section.

24. The packing device according to claim 22, wherein the shape and size of said cut-out portion is determined on the basis of at least one of the weight of said work and the strength of said projection section.

25. The packing device according to claim 22, wherein, in a surface in contact with said work, of said work-movement-regulating section, between one of the edges of said work-movement-regulating section and said cut-out portion, a triangular hole portion is formed, with its apex portion directed toward said edge side.

26. The packing device according to claim 25, wherein said triangular hole portion is arranged substantially symmetrically with respect to a center line about the width direction of said work, in said surface in contact with said work.

27. The packing device according to claim 25, wherein the shape, size and arranging position of said triangular hole portion is determined on the basis of at least one of the weight and shape of said work.

28. The packing device according to claim 22, wherein said work-holding surface section and said work-movement-regulating section are formed out of corrugated cardboard.
